(19) United States
(12) Patent Application Publication
(10) Pub. No.: US 2013/0158210 A1
(43) Pub. Date: Jun. 20, 2013

(54) REDUCTION OF THE FRACTION OF MONOMERS COMPRISING ISOCYANATE GROUPS IN MOISTURE-CURING POLYURETHANE COMPOSITIONS

(71) Applicants: Laila Hossain, Zurich (CH); Dario Veghini, Schinznach-Dorf (CH)

(72) Inventors: Laila Hossain, Zurich (CH); Dario Veghini, Schinznach-Dorf (CH)

(73) Assignee: SIKA TECHNOLOGY AG, Baar (CH)

(21) Appl. No.: 13/819,433

(22) PCT Filed: Oct. 6, 2011
(86) PCT No.: PCT/EP2011/067478

§ 371 Date: Feb. 27, 2013

(30) Foreign Application Priority Data
Oct. 6, 2010 (EP) 10186742.2

(51) Int. Cl. C08L 75/04

(52) U.S. Cl. CPC C08L 75/04
USPC 525/457

(57) ABSTRACT

The invention relates to a composition having at least one polyurethane polymer comprising isocyanate groups, at least one monomer comprising isocyanate groups, and at least one silicon dioxide comprising on its surface functional groups which are reactive with respect to isocyanate groups. The silicon dioxide is present in the form of particles which have an average particle size of ≦100 μm and a specific surface area of ≧100 m²/g. Furthermore, the functional groups of the silicon dioxide are at least partially reacted with isocyanate groups of the monomer comprising isocyanate groups.

### TECHNICAL FIELD

The invention relates to the field of moisture-curing polyurethane compositions, which are used in particular as elastic adhesives, sealants, and coatings.

### PRIOR ART

Compositions based on polyurethane polymers comprising isocyanate groups have been used for some time as elastic adhesives, sealants, and coatings.

The preparation of the polyurethane polymers comprising isocyanate groups typically is carried out by reacting polyols with an excess of polyisocyanates. Due to the preparation, the polyurethane polymer comprising isocyanate groups comprises a residual fraction of polyisocyanates, i.e. monomers comprising isocyanate groups.

The polyurethane polymers comprising isocyanate groups prepared are usually used without further workup in moisture-curing polyurethane compositions, the residual fraction of monomers comprising isocyanate groups remaining in the composition.

Although, up to a certain fraction, monomers comprising isocyanate groups can advantageously affect the composition, it is desirable or necessary in many applications to reduce the fraction of monomers comprising isocyanate groups in moisture-curing polyurethane compositions.

Different approaches to reduce the monomer content are known.

WO 03/046 040 A1 describes, for example, the reduction in the fraction of monomers comprising isocyanate groups by distillation of the reaction product obtained in the preparation of the polyurethane polymers comprising isocyanate groups, removing any starting materials used in the preparation by distillation. The distillation of polymer compositions is known to be complex and expensive. Furthermore, the setting of the desired monomer content, if any, during its reduction is difficult.

Another way to reduce the monomer content is described in EP 0 951 493 A1, for example, and relates to the reaction of a polyol with at least two different diisocyanates of different reactivity, one of the diisocyanates being an unsymmetrical diisocyanate. The implementation of this approach is very complex and also has the disadvantage that unsymmetrical isocyanates are often expensive. Furthermore, the design of the polyurethane comprising isocyanate groups is limited by the limited availability of unsymmetrical isocyanates.

### SUMMARY OF THE INVENTION

Thus, it is an object of the present invention to provide a composition having at least one polyurethane comprising isocyanate which comprises a lower fraction of monomers comprising isocyanate groups.

According to the invention, this object is achieved by a composition of claim 1.

Surprisingly, it was found that the use of a silicon dioxide comprising on its surface functional groups which are reactive with respect to isocyanate groups, effects a reduction in the fraction of monomers comprising isocyanate groups in compositions having at least one polyurethane polymer comprising isocyanate groups, without affecting the composition.

Other aspects of the invention are the subject of further independent claims. Particularly preferred embodiments of the invention are subject of the dependent claims.

### WAYS OF PRACTICING THE INVENTION

The present invention relates to a composition having
at least one polyurethane polymer comprising isocyanate groups;
at least one monomer comprising isocyanate groups; and
at least one silicon dioxide comprising on its surface functional groups which are reactive with respect to isocyanate groups.

In this context, the silicon dioxide is present in the form of particles which have an average particle size of ≦100 μm and a specific surface area of ≧100 m²/g.

Furthermore, the functional groups of the silicon dioxide are at least partially reacted with isocyanate groups of the monomer comprising isocyanate groups.

In the present document, substance names beginning with “poly” such as polyol or polyisocyanate designate substances which formally contain two or more of the functional groups appearing in their name per molecule.

In the present document, the term “polymer” includes on one hand a group of chemically uniform macromolecules, which differ in terms of degree of polymerization, molar mass and chain length, which were prepared by a poly reaction (polymerization, polyaddition, polycondensation). On the other hand, the term includes also derivatives of such group of macromolecules from poly reactions obtained by reactions, such as additions or substitutions, of functional groups on existing macromolecules and which can be chemically uniform or chemically non-uniform. The term also includes so-called prepolymers, i.e., reactive oligomeric preadducts, the functional groups of which are involved in the construction of macromolecules.

The term “polyurethane polymer” includes all polymers which are prepared by the so-called diisocyanate polyaddition process. This also includes those polymers which are nearly or completely free of urethane groups. Examples of polyurethane polymers are polyether polyurethanes, polyester polyurethanes, polyether-polyureas, polyureas, polyester polyureas, polyisocyanurates and polycarbodiimides.

In the present document, the terms “silane” or “organosilane” designate compounds, comprising on the one hand at least one, usually two or three, alkoxy or acyloxy groups, which are bound by way of Si—O bonds directly to the silicon atom, and comprising on the other hand at least one organic moiety, which is bound by way of Si—C bond directly to the silicon atom. Such silanes are known in the art as organoalkoxysilanes or organocyloxysilanes. According to this definition, “tetraalkoxysilanes” shall therefore not represent organosilanes.

“Aminosilanes” or “mercaptosilanes” designate organosilanes, the organic moiety of which comprises an amino group or a mercapto group.

In the present document “molecular weight” is understood to mean weight average molecular weight Mₙ (number average).

“Room temperature” is understood to mean a temperature of 23° C.

The polyurethane polymer comprising isocyanate groups contained in the composition is typically obtained from the reaction of at least one polyol with at least one polyisocyanate, as well known to those skilled in the art.

Suitable polyols are, in particular, polyether polyols, polyester polyols and polycarbonate polyols and mixtures of these polyols, particularly polyoxyethylene polyol, polyoxypropylene polyol and polyoxypropylene polyoxyethylene polyol, preferably polyoxyethylene diol, polyoxypropylene diol, polyoxyethylene triol, polyoxypropylene triol, polyoxypropylene polyoxyethylene diol and polyoxypropylene polyoxyethylene triol.

Suitable polyols preferably have an average molecular weight of 250 to 30,000 g/mol, in particular from 400 to 8000 g/mol, and mean OH functionality ranging from 1.6 to 3.

Suitable polyols are commercially available under the trade name Acclaim® 4200 N from Bayer MaterialScience AG, Germany, for example.

Suitable polyisocyanates are commercially available aliphatic, cyclo-aliphatic or aromatic polyisocyanates. Particularly suitable are diisocyanates such as 1,6-hexamethylene diisocyanate (HDI). 2,2,4- and 2,4,4-trimethyl-1,6-hexamethylene diisocyanate (TMDI), 1-isocyanato-3,3,5-trimethyl-5-isocyanatomethyl-cyclohexane (=isophorone diisocyanate or IPDI), 2,4- and 2,6-toluene diisocyanate (TDI), 4,4′-, 2,4′- and 2,2′-diphenylmethane diisocyanate (MDI). In this context, technical mixtures of MDI with a high content of 4,4′-MDI are particularly suitable.

Suitable polyols and polyisocyanates are those described in patent application WO 2010/049 516 A1 for the preparation of the polyurethane polymer PUP, for example, the disclosure of which is hereby incorporated by reference.

Preferred compositions may also include a plurality of different polyurethane polymers comprising isocyanate groups which have been prepared using different polyisocyanates. For example, the composition includes at least one polyurethane polymer comprising isocyanate groups of a polymeric diol and MDI as the diisocyanate and a polyurethane polymer comprising isocyanate groups of a polymeric diol and TDI as the diisocyanate.

Preferably, the polyurethane polymers comprising isocyanate groups contained in the composition of the invention have an average molecular weight of 1,000 to 50,000 g/mol, in particular from 2000 to 30,000 g/mol, and a mean NCO functionality ranging from 1.8 to 3.

Furthermore, the composition of the invention contains at least one monomer comprising isocyanate groups, the isocyanate groups of which are at least partially reacted with the functional groups of the silicon dioxide.

The at least partial reaction of the isocyanate groups of the monomer comprising isocyanate group with the functional groups of the silicon dioxide takes place upon combining the composition with the silicon dioxide.

The at least one monomer comprising isocyanate groups contained in the composition is typically a diisocyanate and is derived from the preparation of the polyurethane comprising isocyanate groups, as described above. Therefore, the monomer comprising isocyanate groups is typically a starting material in the preparation of the polyurethane polymer, which is obtained in particular because the diisocyanate is used at a stoichiometric excess with respect to the polyol in the preparation of an isocyanate group-terminated polyurethane polymers.

Where the composition is one that contains a plurality of different polyurethane polymers comprising isocyanate groups which have been prepared using different polyisocyanates, the composition usually also contains different monomers comprising isocyanate groups. In this context, these are MDI and TDI, for example, as already described above.

The fraction of monomer comprising isocyanate groups which remains in the composition is, in particular, ≦1.5% by weight, preferably ≦1% by weight, based on the weight of the total composition.

In a preferred compositions having at least one polyurethane polymer comprising isocyanate groups from a polymeric diol and MDI as the diisocyanate, and thus also a residual content of monomeric MDI, the amount of MDI is, in particular, ≦0.1% by weight, based on the weight of the total composition.

Furthermore, the composition of the invention has at least one silicon dioxide comprising on its surface functional groups which are reactive with respect to isocyanate groups, wherein the functional groups of the silicon dioxide are at least partially reacted with isocyanate groups of the monomer comprising isocyanate groups.

In this context, the silicon dioxide is present in the form of particles which have an average particle size of ≦100 μm. In particular, the average particle size is ≧1 μm, preferably in the range from 50 to 60 μm. The particles can have any shape such as spheres, chips, flakes and the like. In particular, they are spherical.

Furthermore, the particles have a specific surface area of ≧100 m²/g. In particular, the particles have a specific surface area of ≧300 m²/g, preferably in the range from 400 to 800 m²/g.

Preferably, the silicon dioxide is present in the form of particles that are porous, wherein the pores have a size in the range of 0.4 to 50 nm, in particular, 1 to 20 nm. Particularly suitable are particles having a pore size in the range from 5 to 10 nm.

In this context, the specific surface area is measured by means of nitrogen adsorption using a gas adsorption instrument from Beckman Coulter, inc., USA, according to the BET method (EN ISO 18757). The pore size distribution can be calculated from the adsorption curve, which is obtained from the measurement of the specific surface area.

Porous particles with a large specific surface area on the one hand have the advantage that they can have a large number of functional groups per particle. On the other hand, they have the advantage that their functional groups selectively react with the isocyanate groups of the monomer comprising isocyanate groups, and only to a small extent with the isocyanate groups of the polyurethane polymer comprising isocyanate groups. Because of the porosity, the functional groups of the silicon dioxide are difficult to access for the polyurethane polymer.

In particular, the silicon dioxide is functionalized on its surface with functional groups which are reactive with respect to isocyanate groups, i.e., the surface of the silicon dioxide is chemically modified.

Furthermore it is also possible that the functional groups which are reactive with respect to isocyanate groups are enriched by adsorption of suitable compounds on the surface of the silicon dioxide. Adsorptively and covalently bound functional groups may also be present.

The functional groups which are reactive with respect to isocyanate groups are in particular amino, mercapto, carboxyl, or thiourea groups, preferably amino groups.

The advantage of a silicon dioxide functionalised with amino groups is that amino groups have a particularly high reactivity with respect to isocyanate groups.

Compared to non-functionalized silicon dioxide, which often has hydroxyl groups on its surface, which are also reactive with respect to isocyanate groups, functionalized silicon dioxides, as described above, lead to a much more efficient reduction in the fraction of monomers comprising isocyanate groups.

Preferably, the silicon dioxide is functionalised with an organosilane, the organic moiety of which has at least one functional group, which is reactive with respect to isocyanate groups. The functionalization of the silicon dioxide is known in the art and takes place, in particular, by combining silicon dioxide with the organosilane.

Particularly suitable organosilanes are aminosilanes or mercaptosilanes. Examples of suitable organosilanes are 3-aminopropyl trimethoxysilane, N-butyl-3-aminopropyl trimethoxysilane, N-phenyl-3-amino-propyl trimethoxysilane, 3-mercaptopropyl trimethoxysilane, and analogs of said organosilanes having at the silicon ethoxy or isopropoxy groups instead of the methoxy groups.

Also suitable organosilanes are di- or triamino-functional organosilanes such as N-(2-aminoethyl)-3-aminopropyl trimethoxysilane or N-(2-aminoethyl)-N′-[3-(trimethoxysilyl)propyl]ethylene diamine.

By using a silicon dioxide, as described above, in compositions having at least one polyurethane polymer comprising isocyanate groups, the residual fraction of monomers comprising isocyanate groups, which remains in the composition, in particular, due to the preparation of the polyurethane polymer comprising isocyanate groups, can be removed or reduced.

The advantage of the silicon dioxide described is that its functional groups react very selectively with the isocyanate groups of the monomer, the isocyanate groups of the polyurethane polymer therefore being available tor the curing of the composition.

Particularly suitable functionalized silicon dioxide is commercially available under the trade name QuadraSil™ AP, MP or TA from Johnson Matthey plc, UK, for example.

The fraction of silicon dioxide comprising on its surface functional groups which are reactive with respect to isocyanate groups is in particular 0.01 to 10% by weight, in particular 0.5 to 5% by weight, preferably 0.5-3% by weight, based on the total weight of the composition.

Furthermore, the composition of the invention may contain other components which are typical in polyurethane chemistry, and in particular in the field of moisture-curing adhesives and sealants based on polyurethane polymers customary and well known to the person skilled in the art.

Typically, such other components include fillers, catalysts, adhesion promoters, rheology modifiers, plasticizers, reactive diluents, drying agents and the like.

In particular, the composition of the invention additionally contains at least one filler.

Suitable fillers are inorganic or organic fillers, for example, natural, ground or precipitated calcium carbonates, which are optionally coated with fatty acids, in particular, with stearic acid, barium sulfate (BaSO₄, also called barite or heavy spar), calcined kaolin, aluminum oxides, aluminum hydroxides, silicic acids, in particular, highly dispersed silicic acids from pyrolysis processes, carbon blacks, especially industrially produced carbon black, PVC powders or hollow spheres. Preferred fillers are calcium carbonates, calcined kaolins, carbon black, highly dispersed silicic acids, and flame-retardant fillers, such as hydroxides or hydrates, particularly hydroxides or hydrates of aluminum, preferably aluminum hydroxide.

It is quite possible and may even be advantageous to use a mixture of different fillers.

A suitable amount of filler is, for example, in the range from 10 to 70% by weight, in particular from 15 to 60% by weight, preferably from 30 to 60% by weight, based on the total composition.

Furthermore, the present invention relates to a method for reducing the fraction of monomers comprising isocyanate groups in compositions having at least one polyurethane polymer comprising isocyanate groups and at least one monomer comprising isocyanate groups, comprising the steps of
providing a composition containing at least one polyurethane polymer comprising isocyanate groups, and at least one monomer comprising isocyanate groups;
combining the composition with a silicon dioxide comprising on its surface functional groups which are reactive with respect to isocyanate groups, wherein the silicon dioxide is present in the form of particles which have an average particle size of ≦100 μm and a specific surface area of ≧100 m²/g.

This method of the invention leads to a reduction in the fraction of monomers comprising isocyanate groups in the composition.

Preferred silicon dioxide comprising on its surface functional groups which are reactive with respect to isocyanate group, has been described above.

In a first embodiment of the method of the invention, the composition having at least one polyurethane polymer comprising isocyanate groups and at least one monomer comprising isocyanate groups is a composition obtained directly and without further workup from the preparation of the polyurethane polymer comprising isocyanate groups. Such composition typically includes the polyurethane polymer comprising isocyanate groups as the reaction product, residual fractions of the starting materials as well as any further components known in the art, which are needed for the preparation of the polyurethane polymer.

Combing such composition with the functionalized silicon dioxide is usually carried out with continuous stirring under inert gas atmosphere at room temperature, optionally using also suitable catalysts, such as organotin compounds, such as those usually used for addition reactions of isocyanates.

Following the reaction of its functional groups with the monomers comprising isocyanate groups, the silicon dioxide used may remain in the composition for its further use, or it may be removed from the composition by filtration, for example.

In case that the silicon dioxide used is supposed to remain in the composition after the reaction of its functional groups with the polyurethane monomer comprising isocyanate groups, combining of the composition having at least one polyurethane polymer comprising isocyanate groups and at least one monomer comprising isocyanate groups with the functionalized silicon dioxide can also take place by passing the composition through a bed or pack of silicon dioxide described, typically in a fixed or fluidized bed reactor.

In a second embodiment, the composition having at least one polyurethane polymer comprising isocyanate polyurethane and at least one monomer comprising isocyanate groups is a composition as obtained from the preparation of the polyurethane polymers comprising isocyanate groups, the composition including already other components typically used for the use of the composition as an adhesive, sealant or coating such as those mentioned above.

In this embodiment of the method, combining the composition with the functionalized silicon dioxide takes place in particular in a vacuum mixer at temperatures ranging from 20° C. to 100° C.

The advantage of this embodiment of the method is that the method can in principle be applied also to ready-to-use compositions based on polyurethane polymers comprising isocyanate groups to reduce the fraction of monomers comprising isocyanate groups.

Most preferably, the method of the invention provides a composition, which is obtained directly and without further workup from the preparation of the polyurethane polymer comprising isocyanate groups and combined with the functionalized silicon dioxide, as is described in the first embodiment of the method.

The advantage of this embodiment is on the one hand that the reduction of the monomer content is very efficient. On the other hand, this embodiment has the advantage that if can be selectively used for the reduction of the fraction of a specific monomer in the case of compositions having a plurality of different polyurethane polymer comprising isocyanate groups.

In particular, the method of the invention is suitable for the reduction of the fraction of symmetric diisocyanates such as MDI, typically in compositions having at least one polyurethane polymer comprising isocyanate groups from a polymeric diol and MDI as the diisocyanate.

The invention further relates to a composition obtained by a method for reducing the fraction of monomers comprising isocyanate groups in compositions having at least one polyurethane polymer comprising isocyanate groups and at least one monomer comprising isocyanate groups, as described above.

The compositions described above are preferably prepared and stored in the absence of moisture. Typically, the composition is storage-stable, which means that in the absence of moisture it can be stored in a suitable container or arrangement, such as a drum, a bag or a cartridge, over a period of several months to a year and longer without any changes with respect to its application properties or its properties after curing to an extent relevant for its use.

Furthermore, the present invention relates to the use of a composition described above as moisture-curing adhesive, sealant or coating which may be applied in particular at room temperature or at an elevated temperature up to 100° C., for example.

Likewise, the invention relates to a cured composition which may be obtained from the reaction of a composition as described above, with water, especially in the form of humidity.

Furthermore, the present invention relates to the use of silicon dioxide comprising on its surface functional groups which are reactive with respect to isocyanate groups, to reduce the fraction of monomers comprising isocyanate groups in compositions having at least one polyurethane polymer comprising isocyanate groups and at least one monomer comprising isocyanate groups.

In this context, the silicon dioxide is present in the form of particles which have an average particle size of ≦100 μm and a specific surface area of ≧100 m²/g.

Preferred silicon dioxide comprising on its surface functional groups which are reactive with respect to isocyanate groups, has been described already above.

### EXAMPLES

In the following, exemplary embodiments are provided which illustrate the invention described in more detail. Naturally, the invention is not limited to these exemplary embodiments described.

### Test Procedure

The tensile strength, the elongation at break, and the modulus of elasticity (E-module) at 0 to 5% elongation were determined according to DIN EN 53504 (rate of pull: 200 mm/min) in films with a layer thickness of 2 mm cured for 7 days at 23° C. and 50% relative humidity.

The modulus of shear (also called G-module) was determined according to DIN 54451, wherein two aluminum specimens (70×25×5 mm), which were pre-treated with Sika® Primer-204 N (available from Sika Schweiz AG), were glued on a 10×25 mm area with an adhesive layer thickness of 1.75 mm, and cured for 7 days at 23° C. and 50% relative humidity. Subsequently, the test specimens were pulled apart at a speed of 10 mm/rain. The modulus of shear is measured at 10% slip.

To determine the dispensing force the adhesives were filled in infernally coated aluminum cartridges. After conditioning for 12 hours at 23° C., the cartridges were opened and dispensed by means of a dispensing instrument. In this context, a nozzle with 5 mm inner diameter has been screwed onto the cartridge. Using a dispensing instrument (Zwick/Roell 2005), the force was determined that was needed to dispense the sealant at a dispensing speed of 60 mm/min. The indicated value is the mean of the forces that were measured after a dispensing distance of 22 mm, 24 mm, 26 mm and 28 mm. At a dispensing distance of 45 mm, the measurement was stopped.

The monomer content for MDI and TDI was determined as follows: Approx, 150 mg of sample was weighed in a 10 ml volumetric flask and dissolved with dry acetonitrile up to the mark. After derivatization with 1% by volume of N-propyl-4-nitrobenzylamine in acetonitrile (1:1 ratio by volume), the sample was left for 30 minutes and then filtered through a nylon membrane (pore size of 0.2 μm). The clear, colorless solution was analyzed by HPLC PDA detector (HPLC system: Varian ProStar LC system; detector Varian ProStar 330 photodiode array; column: Kinetex 100 PEP, 2.6 μm 100×3 mm; column oven: 30° C.; mobile phase A: 0.04 M sodium acetate (pH 4.5); mobile phase C: acetonitrile; HPLC method: SOP-390C; flow rate: 0.7 ml/min; detection channel 1: UV 275 nm (2,6-, 2,4-TDI and c/t-IPDI); detection channel 2: UV 250 nm (2,4′-MDI and 4,4′-MDI); injection volume: 10 μl).

### Preparation of the Polyurethane Polymer Comprising Isocyanate Groups P1

1300 g of polyoxypropylene diol (Acclaim® 4200 N, Bayer MaterialScience AG; OH number 28.5 mg KOH/g), 2600 g of polyoxypropylene polyoxyethylene triol (Caradol® MD34-02, Shell Chemicals Ltd., UK; OH number 35.0 mg KOH/g), 600 g of 4,4′-methylene diphenyl diisocyanate (4,4′-MDI; Desmodur® 44 MC L, Bayer Material Science AG) and 500 g of diisodecyl phthalate (DIDP; Palatinol® Z, BASF SE, Germany) were reacted according to a known method at 30° C. to give an NCO-terminated polyurethane polymer having a free isocyanate group content of 2.05% by weight.

The polyurethane polymer comprising isocyanate groups P1 thus prepared has an MDI monomer content of 2.38% by weight.

The reduction in the fraction of monomers comprising isocyanate groups was determined by measurement of the monomer content in P1 and subsequent combining of P1 with QuadraSil™ AP, a silicon dioxide comprising on its surface amino groups. In this context, 2 g of P1 were placed in a 30 ml polypropylene container and flushed with nitrogen. Then, 0.15 g of QuadraSil™ AP was added and the container was sealed. The samples were mixed using a SpeedMixer™ of Hauschild Engineering, Germany for 30 seconds at 330 rpm at 23° C., then left to stand for one hour. The mixing process was repeated twice. Then, the monomer content was measured again, now a monomer content of 0.20% by weight was measured. This corresponds to a monomer reduction of about 92% (average of three measurements).

### Preparation of the Adhesives

The adhesives were prepared as follows, the respective fractions in parts by weight of the individual components being provided in Table 1: A vacuum mixer was charged with polyurethane polymer P1 comprising isocyanate. At room temperature, QuadraSil™ AP or QuadraSil™ AP (denat.) was added and stirred for 30 minutes. The mixture was then heated to 60° C., and DIDP was added. Then, carbon black and chalk were added and further stirred at 60° C., then cooled to 50° C. Finally, the catalyst was added and the mixture was processed for a further 10 minutes at 50° C. to form a homogeneous paste, then cooled to room temperature, and flushed with nitrogen. The adhesives prepared were then filled into internally coated aluminum spreader piston cartridges.

Example 1 does not contain any QuadraSil™ AP. In Example 4, the QuadraSil™ AP was added together with the plasticizer, i.e. without separate stirring, and only stirred for 5 minutes. In Example 5, the QuadraSil™ AP was added immediately after the catalyst. Examples 1 and 8 are reference examples.

| | 1 | 2 | 3 | 4 | 5 | 6 | 7 | 8 |
|---|---|---|---|---|---|---|---|---|
| P1 | 39.82 | 39.4 | 39.2 | 39.22 | 39.22 | 38.65 | 37.9 | 38.65 |
| QuadraSil ™ AP | — | 0.75 | 1.5 | 1.5 | 1.5 | 2.94 | 4.81 | — |
| QuadraSil ™ AP (denat.) ^{a)} | — | — | — | — | — | — | — | 2.94 |
| DIDP ^{b)} | 22.64 | 22.4 | 22.3 | 22.3 | 22.3 | 21.97 | 21.55 | 21.97 |
| Carbon black | 17.89 | 17.7 | 17.62 | 17.62 | 17.62 | 17.36 | 17.03 | 17.36 |
| Chalk | 16.65 | 18.45 | 18.37 | 18.37 | 18.37 | 18.1 | 17.75 | 18.1 |
| p-Toulenesulfonylisocyanate | — | 0.3 | — | — | — | — | — | — |
| Catalyst ^{c)} | 1.01 | 1 | 1 | 1 | 1 | 0.98 | 0.96 | 0.98 |
| MDI content [% by weight] | 0.94 | 0.76 | 0.42 | 0.44 | 0.42 | 0.08 | 0 ^{d)} | 0.55 |
| MDI reduction [%] | — | 19.1 | 55.3 | 54.2 | 55.3 | 91.5 | 100 ^{d)} | 41.5 |
| G-module (10%) [MPa] | 1.51 | 1.26 | 1.19 | 1.17 | 1.25 | 1.16 | 1.01 | 1.33 |
| E-module (0.5-5%) [MPa] | 4.26 | 3.37 | 3.55 | 3.69 | 3.61 | 3.44 | 2.95 | 4.14 |
| Elongation at break [%] | 537 | 594 | 487 | 521 | 516 | 436 | 429 | 474 |
| Tensile strength [MPa] | 8.88 | 7.81 | 7.03 | 7.78 | 7.52 | 6.46 | 5.87 | 7.25 |
| Dispensing force [N] | 482 | 525 | 541 | 615 | 564 | 704 | 1440 | 551 |

Adhesive compositions by weight and results;
^{a)} Thermally denatured QuadraSil ™ AP (conditions: 4 hours at 700° C.);
^{b)} Diisododecyl phthalate;
^{c)} Dibutyltin dilaurate;
^{d)} MDI content is below the detection limit, i.e. ≦0.01 % by weight.

1. A composition, comprising
at least one polyurethane polymer comprising isocyanate groups;
at least one monomer comprising isocyanate groups; and
at least one silicon dioxide comprising on its surface functional groups which are reactive with respect to isocyanate groups,
wherein the silicon dioxide is present in the form of particles which have an average particle size of ≦100 μm and a specific surface area of ≧100 m²/g; and
wherein the functional groups of the silicon dioxide are at least partially reacted with isocyanate groups of the monomer comprising isocyanate groups.

2. The composition according to claim 1, wherein the silicon dioxide on its surface is functionalized with functional groups which are reactive with respect to isocyanate groups.

3. The composition according to claim 1, wherein the silicon dioxide is present in the form of particles which have an average particle size of ≧1 μm.

4. The composition according to claim 1, wherein the silicon dioxide is present in the form of particles having an average particle size in the range from 50 to 60 μm.

5. The composition according to claim 1, wherein the silicon dioxide is present in the form of particles having a specific surface area in the range of of ≧300 m²/g.

6. The composition according to claim 5, wherein the specific surface area is in the range from 400 to 800 m²/g.

7. The composition according to claim 1, wherein the silicon dioxide is present in the form of particles which are porous, the pores having a size in the range from 0.4 to 50 nm.

8. The composition according to claim 1, wherein the functional groups which are reactive with respect to isocyanate groups are amino groups.

9. The composition according to claim 1, wherein the silicon dioxide is functionalized with an organosilane the organic moiety of which comprises at least one functional group which is reactive with respect to isocyanate groups.

10. The composition according to claim 1, wherein the fraction of the silicon dioxide is from 0.01 to 10% by weight, based on the total composition.

11. The composition according to claim 1, wherein the composition has a content of monomers comprising isocyanate groups of ≧1.5% by weight, based on the total composition.

12. (canceled)

13. A method for reducing the fraction of monomers comprising isocyanate groups in a composition having at least one polyurethane polymer comprising isocyanate groups and at least one monomer comprising isocyanate groups, comprising the steps of
providing a composition containing at least one polyurethane polymer comprising isocyanate groups, and at least one monomer comprising isocyanate groups;
combining the composition with a silicon dioxide comprising on its surface functional groups which are reactive with respect to isocyanate groups,
wherein the silicon dioxide is present in the form of particles which have an average particle size of ≦100 μm and a specific surface area of ≧100 m²/g.

14. A method of reducing the fraction of monomers comprising isocyanate groups in compositions having at least one polyurethane polymer comprising isocyanate groups and at least one monomer comprising isocyanate groups with silicon dioxide comprising on its surface functional groups which are reactive with respect to isocyanate groups,
wherein the silicon dioxide is present in the form of particles which have an average particle size of ≦100 μm and a specific surface area of ≧100 m²/g.
